(19) United States
(12) Patent Application Publication
(10) Pub. No.: US 2019/0001752 A1
(43) Pub. Date: Jan. 3, 2019

(54) HEAVY TRUCK TIRE TREAD AND HEAVY TRUCK TIRE

(71) Applicant: Compagnie Generale des Etablissements Michelin, Clermont-Ferrand (FR)

(72) Inventors: VICTOR ABAROTIN, GREER, SC (US); DANIEL HICKS, GREENVILLE, SC (US)

(21) Appl. No.: 16/066,734

(22) PCT Filed: Dec. 14, 2016
(86) PCT No.: PCT/US16/66511

§ 371 Date: Jun. 28, 2018

Related U.S. Application Data
(60) Provisional application No. 62/271,454, filed on Dec. 28, 2015.

(51) Int. Cl. B60C 11/03; B60C 11/13

(52) U.S. Cl. CPC B60C 11/0302; B60C 11/0327; B60C 2200/08; B60C 2011/0372; B60C 2011/0344; B60C 11/13

(57) ABSTRACT

The invention provides for a heavy truck tire tread having a longitudinal direction, a lateral direction and a thickness direction, said tread comprising : a pair of opposing tread edges (21, 21′) spaced apart along the lateral direction; a tread region extending between the tread edges over a rolling tread width (RTW); a shoulder zone (SZ) adjacent to each tread edge of said pair of opposing tread edges and extending over a lateral length of 10% of the rolling tread width (RTW); and a center zone (CZ) defined between said shoulder zones; wherein the tread region comprises a plurality of ribs (23) separated by grooves (22), said grooves running continuously from the center zone toward each of said tread edges at a groove angle relative to the lateral direction and extending out to the respective tread edge; and wherein a shoulder zone average groove angle is greater than 45° in absolute value; the shoulder zone average groove angle is greater than a center zone average groove angle in absolute values; and the grooves are running toward the tread edges

### FIELD OF THE INVENTION

This invention relates generally to tire treads and tires. More specifically, this invention relates to tire treads and tires best suitable for the drive axle(s) of heavy trucks such as the drive axle(s) of tractors used in tractor-semi-trailer combinations or in single unit straight trucks.

### BACKGROUND OF THE INVENTION

One problem with treads for drive tires is the compromise between traction, rolling resistance and (irregular) wear.

### SUMMARY OF THE INVENTION

The invention provides for a heavy truck tire tread having a longitudinal direction, a lateral direction and a thickness direction, said tread comprising :

a pair of opposing tread edges spaced apart along the lateral direction;
a tread region extending between the tread edges over a rolling tread width;
a shoulder zone adjacent to each tread edge of said pair of opposing tread edges and extending over a lateral length of 10% of the rolling tread width; and
a center zone defined between said shoulder zones; wherein the tread region comprises a plurality of ribs separated by grooves, said grooves running continuously from the center zone toward each of said tread edges at a groove angle relative to the lateral direction and extending out to the respective tread edge; and wherein:
a shoulder zone average groove angle is greater than 45° in absolute value;
the shoulder zone average groove angle is greater than a center zone average groove angle in absolute values; and
the grooves are running toward the tread edges against a rolling direction of the tire.

In another embodiment, the ribs are blunted where the grooves are opening out to a tread edge, a lateral length of said blunting being less than 25 mm.

In another embodiment, said lateral length of said blunting is at least 2 mm.

In another embodiment, said lateral length of said blunting is at least 5 mm.

In another embodiment, said lateral length of said blunting is at least 10 mm.

In another embodiment, said lateral length of said blunting is between 15 and 20 mm.

In another embodiment, said shoulder zone average groove angle is less than 70° in absolute value.

In another embodiment, said shoulder zone average groove angle is greater than 50° in absolute value.

In another embodiment, said center zone average groove angle is less than 50° in absolute value.

In another embodiment, said center zone average groove angle is greater than 10° in absolute value.

In another embodiment, a difference between said center zone average groove angle and said shoulder zone average groove angle in absolute values is comprised between 10° and 60°, preferably between 20° and 50°.

In another embodiment, the center zone comprises at least one circumferential groove.

The invention also provides for a heavy truck tire comprising such a tread.

The foregoing and other objects, features and advantages of the invention will be apparent from the following more detailed descriptions of a particular embodiment of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a heavy truck tire comprising an embodiment of the disclosed tire tread.

FIG. 2 is a front view of the heavy truck tire of FIG. 1.

FIG. 3 is a front view of part of the tread of FIGS. 1 and 2 showing details of its design at a much bigger scale.

FIG. 4 is a partial view, even more magnified, limited to the left part of the full-width view of FIG. 3.

FIGS. 5 to 11 are front views of other embodiments of the tread.

FIG. 12 is a perspective view of an embodiment of the heavy truck tire comprising the tread of FIG. 9.

FIG. 13 is a detail view showing an example of how the grooves could connect with the tread edges.

FIGS. 14 to 18 simply illustrate different examples of how the grooves could connect with the tread edges.

The use of the same or similar reference numerals in the figures denotes the same or similar features.

### DETAILED DESCRIPTION OF PARTICULAR EMBODIMENTS

Reference will now be made in detail to embodiments of the invention, examples of which are illustrated in the drawings. These examples are provided by way of explanation of the invention.

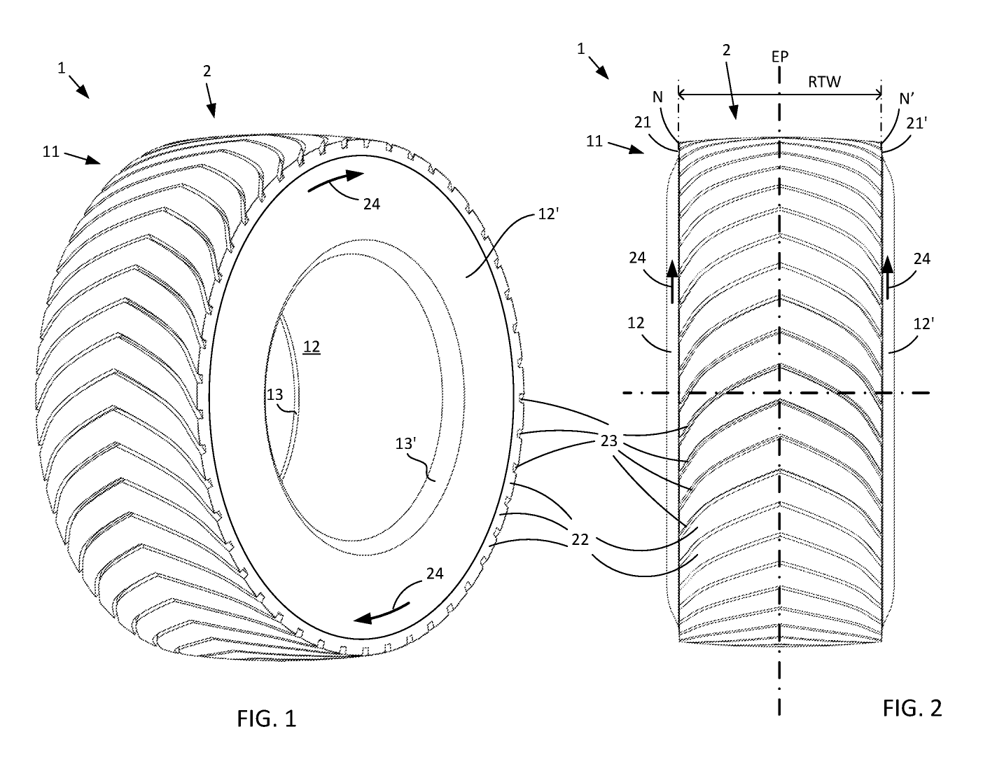

As shown in FIGS. 1 and 2, a heavy truck tire 1 comprises a tread 2 according to an embodiment of the invention.

As shown in FIG. 1, a heavy truck tire 1 generally comprises a crown portion 11 connected by respective sidewalls 12, 12′ to beads portions 13, 13′.

The tread 2 has a longitudinal direction (also referred to as the circumferential direction of the tire), a lateral direction (also referred to as the axial or transverse direction) and a thickness direction (also referred to as the tread depth direction).

The tread has respective tread edges 21, 21′ on each side. A rolling tread width RTW is defined as the distance from a first edge point N to an opposite second edge point N′. The edge points are defined as the maximum axial locations where the tread of the tire no longer comes in contact with the ground under standard, straight rolling conditions (75% of the TRA load at standard pressure for the tire). These locations do not account for tread that may intermittently come into contact with the ground (such as sacrificial shoulder ribs).

The tread has ribs 22 defined by grooves 23 running parallel to each other. The grooves are continuously extending from the tread center to the tread edges and connecting to the side of the tread. The grooves run at an angle relative to the lateral direction.

The design of the tread is substantially symmetric, that is to say that the tread features are arranged substantially symmetrically about the equatorial plane EP. Therefore, equatorial plane EP bisects the tread 2 into opposing halves of substantially the same design. This tread is said to be of a directional design because it has a different look according to which side it is oriented. A directional tire or tread does not only look differently but it also performs differently if used in one rolling direction or the other. This is why directional treads or tires conventionally bear markings that indicate the designed rolling direction. Such markings may be arrows 24 pointing into the designed rolling direction. Using the tire for rolling in the opposite direction would be detrimental to its best performance.

The general orientation of the grooves in the tread is such that they are running from the tread center toward the shoulders against the rolling direction of the tire, that is to say running from the tread center toward the shoulders while running opposite of the rolling direction of the tire.

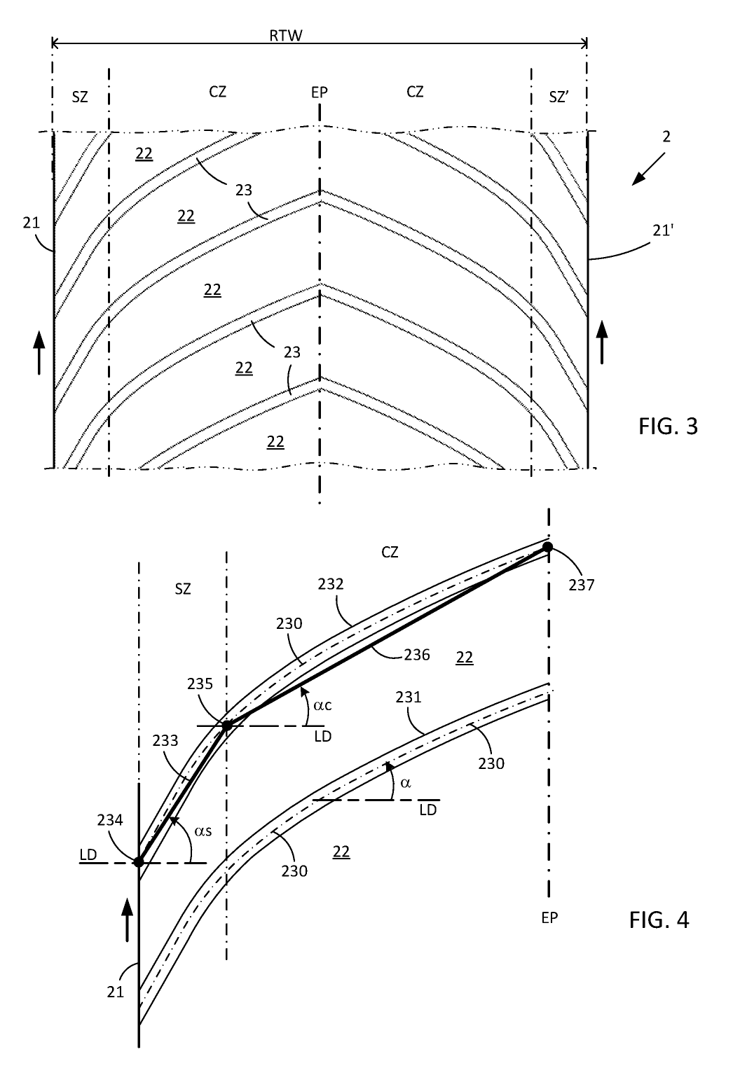

FIG. 3 is a magnified and flattened projection view of a portion of the tread 2 of FIGS. 1 and 2. Tread 2 comprises a shoulder zone SZ, SZ′ adjacent to each one of said pair of opposing tread edges 21, 21′ and extending over a lateral length amounting to 10% of the rolling tread width RTW. A center zone CZ is defined between the two shoulder zones.

FIG. 4 is a partial view, even more magnified, of the tread of FIG. 3 to show even more clearly features like the orientation of the grooves. This partial view is limited to the left part of the full-width view of FIG. 3. Relative to equatorial plane EP, the other half of the tread is substantially symmetric as seen from FIG. 3. But a tread according to the invention may also comprise tread halves that are notably different as long as each tread half remains within the scope of the invention as limited by the claims.

In a first groove 231, a groove median line 230 is representing the orientation of the groove across the tread and α is the angle that this groove median line 230 makes with the lateral direction LD at any point along the groove. Angle α may be positive as represented here or be locally negative at some point where the groove is inclined in the opposite direction or if one looks at a similar tread upside-down.

In the next groove 232, the definition of average angles is explained. A shoulder zone average groove angle αs is defined as the angle that a shoulder groove line 233 is making with the lateral direction LD. The shoulder groove line 233 is defined between a point 234 where the groove median line 230 extends out at the tread edge 21 and a point 235 where the groove median line 230 crosses the separation line between the shoulder zone SZ and the center zone CZ. A center zone average groove angle αc is defined as the angle that a center groove line 236 is making with the lateral direction LD. The center groove line 236 is defined between the point 235 where the groove median line 230 crosses the separation line between the shoulder zone SZ and the center zone CZ and a point 237 where the groove median line 230 meets the equatorial plane EP.

According to the invention, the shoulder zone average groove angle αs is greater than 45° in absolute value and the shoulder zone average groove angle αs is greater than a center zone average groove angle αc in absolute values. Those comparisons are effected in absolute values to make them insensitive to the direction one looks at the tread, be it with the tire rolling direction going up as represented here or upside-down.

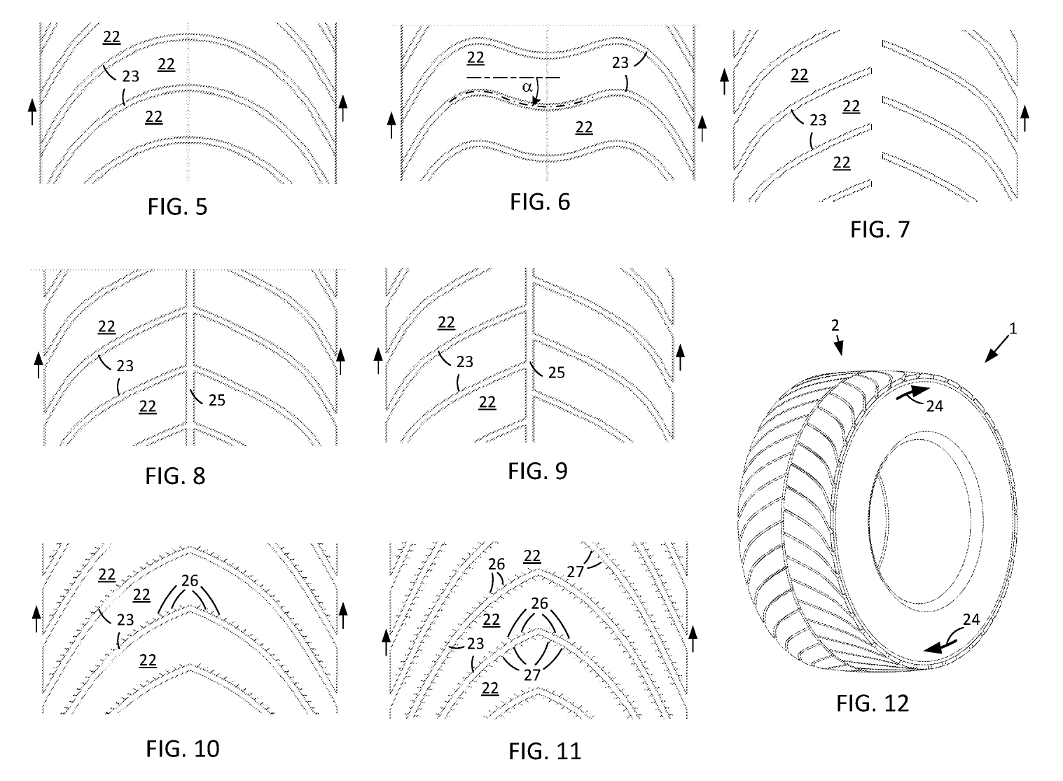

FIG. 5 shows another embodiment of a tread where the groove angle α is varying continuously from a steep angle at the tread edges to being 0° at the equatorial plane.

FIG. 6 shows another embodiment of a tread where the groove angle α is starting from a steep angle at the tread edges, then decreasing continuously until becoming negative in a first part of the center zone and increasing again to become 0° at the equatorial plane.

FIG. 7 shows another embodiment of a tread where the grooves are oriented in a way very similar to the embodiment of FIGS. 1 to 4. The difference here is that the grooves are interrupted near the equatorial plane and do not even reach the equatorial plane. The grooves of each half tread are offset and do not connect.

FIG. 8 shows another embodiment of a tread where the grooves are oriented in a way very similar to the embodiment of FIGS. 1 to 4. The difference here is the presence of a longitudinal groove 25 on the equatorial plane. In another embodiment the longitudinal groove may be located anywhere in the center zone. In yet another embodiment the tread may include more than one longitudinal groove in the center zone.

FIG. 9 shows another embodiment of a tread very similar to the embodiment of FIG. 8. The difference here is that grooves of each half tread are offset and do not connect directly but only via the longitudinal groove 25 on the equatorial plane.

FIG. 10 shows another embodiment of a tread where the grooves are oriented in a way very similar to the embodiment of FIGS. 1 to 4. The difference here is the presence of partial sipes 26 on the trailing edge of each rib 22. The trailing edge of each rib is defined relative to the rolling direction as the edge that is leaving the contact patch as the latest one. Partial sipes 26 are said “partial” because they each have a sipe length shorter than the rib width such that they do not extend fully across the ribs. Each partial sipe is spaced apart along the direction of rib length from an adjacent partial sipe by a spacing. Each partial sipe has a sipe depth. For this exemplary embodiment, spacing distance is less than about 1.5 times the sipe depth. In turn, sipe depth is at least about 50 percent of the height of ribs (also referred as the tread depth). Partial sipes 26 also have a sipe length that is at least about 50 percent of the spacing between partial sipes.

FIG. 11 shows another embodiment that is very similar to the embodiment of FIG. 10. The difference here is the presence of partial sipes 27 on the leading edge of each rib 22. The leading edge of each rib is defined relative to the rolling direction as the edge that is entering the contact patch as the latest one. Partial sipes 27 are otherwise similar to partial sipes 26.

FIG. 12 shows a tire 1 comprising the tread of FIG. 9.

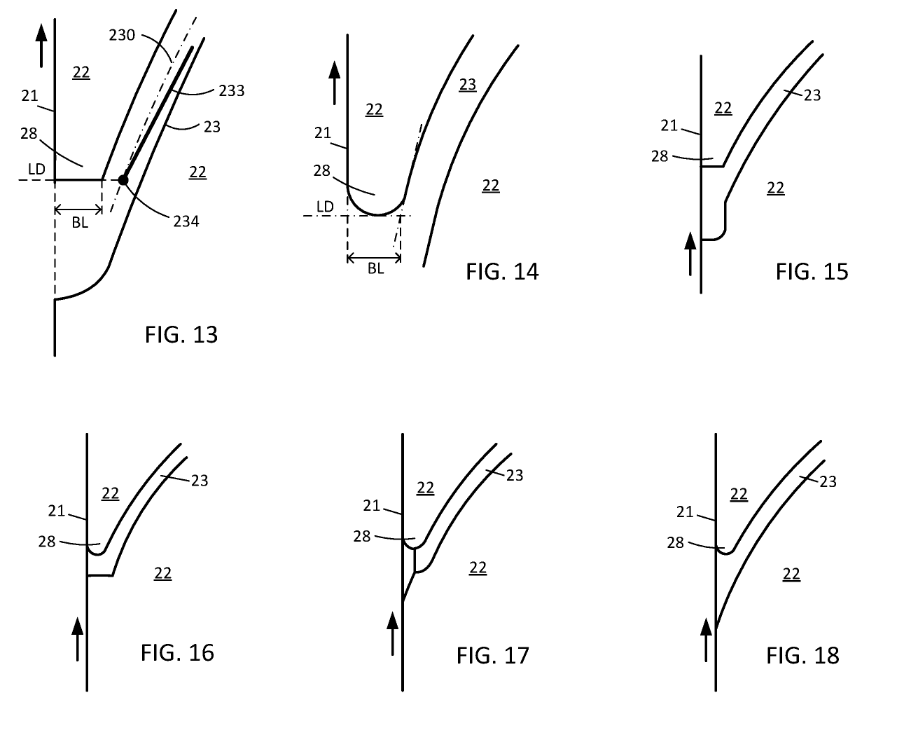

FIG. 13 illustrates a blunting that may be applied at the tip of each rib 22 at the tread edges. In order to protect the tapered tip 28 of each rib where the groove 23 meets the tread edge 21, the tapered tip 28 may be blunted. A blunting length BL is defined along the lateral direction LD between the tread edge and the outside wall of the groove. The blunting length BL is less than 25 mm. Depending on the aggression level typical of the use the tread is designed for, the blunting length BL may be less than 15 mm, 10 mm or even less than 5 mm.

When the rib tips are blunted, the starting point 234 for the shoulder groove line is located where the groove median line 230 passes the lateral direction LD that is tangent to the blunting.

FIG. 14 illustrates another embodiment where the blunting may have a radiused shape.

FIGS. 15 to 18 simply illustrate different examples of shapes that the groove opening may include.

On the drawings, the grooves are shown in the generic and conventional shape of fully open grooves but they could be of many other form. They may for instance be partially hidden grooves that is to say grooves that may not be always fully open to the tread surface. Such grooves may for example undulate along their length between a lower position where they are only connected to the surface by a sipe and a higher position where they are fully open at the surface. Partially hidden grooves may also consist in an under-surface duct connected to the surface by a series of radially extending passages.

It will be apparent to those skilled in the art that various modifications and variations can be made in the present invention without departing from the scope or spirit of the invention. For instance, features illustrated or described as part of one embodiment, can be used with another embodiment to yield a still further embodiment. As already discussed above, a tread or tire according to the invention may also comprise tread halves that are notably different from one another as long as each tread half remains within the scope of the invention as limited by the claims. Thus, it is intended that the present invention covers such modifications and variations as they fall within the scope of the appended claims and their equivalents.

1. A heavy truck tire tread having a longitudinal direction, a lateral direction and a thickness direction, said tread comprising:
a pair of opposing tread edges spaced apart along the lateral direction;
a tread region extending between the tread edges over a rolling tread width;
a shoulder zone adjacent to each tread edge of said pair of opposing tread edges and extending over a lateral length of 10% of the rolling tread width; and
a center zone defined between said shoulder zones;
wherein the tread region comprises a plurality of ribs separated by grooves said grooves running continuously from the center zone toward each of said tread edges at a groove angle (α) relative to the lateral direction and extending out to the respective tread edge; and wherein:
a shoulder zone average groove angle (αs) is greater than 45° in absolute value;
the shoulder zone average groove angle (αs) is greater than a center zone average groove angle (αc) in absolute values; and
the grooves are running toward the tread edges against a rolling direction of the tire wherein the tread is a heavy truck tire tread.

2. A heavy truck tire tread according to claim 1, wherein the ribs are blunted where the grooves are opening out to the tread edge, a lateral length of said blunting being less than 25 mm.

3. A heavy truck tire tread according to claim 2, wherein said lateral length of said blunting is at least 2 mm.

4. A heavy truck tire tread according to claim 2, wherein said lateral length of said blunting is at least 5 mm.

5. A heavy truck tire tread according to claim 2, wherein said lateral length of said blunting is at least 10 mm.

6. A heavy truck tire tread according to claim 2, wherein said lateral length of said blunting is between 15 and 20 mm.

7. A heavy truck tire tread according to claim 1, wherein said shoulder zone average groove angle (αs) is less than 70° in absolute value.

8. A heavy truck tire tread according to claim 1, wherein said shoulder zone average groove angle (αs) is greater than 50° in absolute value.

9. A heavy truck tire tread according to claim 1, wherein said center zone average groove angle (αc) is less than 50° in absolute value.

10. A heavy truck tire tread according to claim 1, wherein said center zone average groove angle (αc) is greater than 10° in absolute value.

11. A heavy truck tire tread according to claim 1, wherein a difference between said center zone average groove angle (αc) and said shoulder zone average groove angle (αs) in absolute values is comprised between 10° and 60°.

12. A heavy truck tire tread according to claim 1, wherein the center zone comprises at least one circumferential groove (25).

13. A Heavy truck tire comprising a tread according to claim 1.

14. A heavy truck tire tread according to claim 11, wherein the difference between said center zone average groove angle (αc) and said shoulder zone average groove angle (αs) in absolute values is comprised between 20° and 50°.

15. A heavy truck tire tread having a longitudinal direction, a lateral direction and a thickness direction, said tread comprising:
a pair of opposing tread edges spaced apart along the lateral direction;
a tread region extending between the tread edges over a rolling tread width;
a shoulder zone adjacent to each tread edge of said pair of opposing tread edges and extending over a lateral length of 10% of the rolling tread width; and
a center zone defined between said shoulder zones;
wherein the tread region comprises a plurality of ribs separated by grooves, wherein the ribs are blunted where said grooves are opening out to the tread edge, a lateral length of the blunting is from 15 to 20 mm, said grooves running continuously from the center zone toward each of said tread edges at a groove angle (α) relative to the lateral direction and extending out to the respective tread edge; and wherein:
a shoulder zone average groove angle (αs) is from 50°-70° in absolute value;
the shoulder zone average groove angle (αs) is greater than a center zone average groove angle (αc) in absolute values, wherein the center zone average groove angle (αc) is from 10°-50° in absolute value; and
the grooves are running toward the tread edges against a rolling direction of the tire.

16. A heavy truck tire tread having a longitudinal direction, a lateral direction and a thickness direction, said tread comprising:
a pair of opposing tread edges spaced apart along the lateral direction;
a tread region extending between the tread edges over a rolling tread width;
a shoulder zone adjacent to each tread edge of said pair of opposing tread edges and extending over a lateral length of 10% of the rolling tread width; and
a center zone defined between said shoulder zones;
wherein the tread region comprises a plurality of ribs separated by grooves, said grooves running continuously from the center zone toward each of said tread edges at a groove angle (α) relative to the lateral direction and extending out to the respective tread edge; and wherein:
a shoulder zone average groove angle (αs) is greater than 45° in absolute value;
the shoulder zone average groove angle (αs) is greater than a center zone average groove angle (αc) in absolute values;
the grooves are running toward the tread edges against a rolling direction of the tire, wherein the tread is a heavy truck tire tread; and
the grooves extend continuously from one of the tread edges to the opposing one of the tread edges.

17. A heavy truck tire according to claim 16, wherein the center zone comprises single circumferential groove and no more than a single circumferential groove.

18. A heavy truck tire according to claim 16, wherein the center zone lacks a circumferential groove.
